(19) United States
(12) Patent Application Publication
(10) Pub. No.: US 2011/0163060 A1
(43) Pub. Date: Jul. 7, 2011

(54) Container for Different Materials With Anti-Disassembly Structure

(76) Inventor: Kuo Cheng Wu, Kaohsiung City (TW)

(21) Appl. No.: 13/041,500

(22) Filed: Mar. 7, 2011

Related U.S. Application Data
(63) Continuation-in-part of application No. 12/683,858, filed on Jan. 7, 2010.

(51) Int. Cl. B65D 1/04; B65D 55/02; A61J 1/14

(52) U.S. Cl. 215/6; 215/216

(57) ABSTRACT

A container with an anti-disassembly structure for receiving different materials is proposed. The container includes a first vessel and a second vessel coupling with each other in a screw way, while a partition is arranged in the second vessel to separate a room sealed by the first and second vessels into two parts. Particularly, an anti-disassembly unit is arranged between these two vessels, with a plurality of ratchets formed on one of the two vessels and a plurality of flexible pawls formed on the other one of these vessels. Accordingly, the first vessel is prevented from being rotated in a reverse direction relative to the second vessel to disengage from the second vessel, and thus an anti-disassembly function is achieved.

This is a continuation-in-part application of U.S. patent application Ser. No. 12/683,858 filed on Jan. 7, 2010.

### BACKGROUND OF THE INVENTION

1. Field of the Invention

The invention relates to a container for receiving different materials, and especially to a container with an anti-disassembly structure to prevent any of the materials form leaking out of the container due to disassembly.

2. Description of the Related Art

Referring to FIG. 1, which illustrates a container for receiving two kinds of different injections that are separately sealed in the container to be kept away from outer contaminants and to avoid mixing with each other, the container has a first vessel 91, a second vessel 92, a cover 93, and a partition 94. The first vessel 91 has two ends 911, 912, a lateral wall 913, and a first compartment 914, with the lateral wall 913 connecting the two ends 911, 912 and the first compartment 914 being defined by the two ends 911, 912 and lateral wall 913. An entrance opening 915 is formed at the end 911 and communicated with the first compartment 914, while a first communicating opening 916 is formed at the other end 912 and communicated with the first compartment 914. Particularly, a first thread 917 is formed on the outer side of the lateral wall 913. The second vessel 92 has a surrounding wall 921 and a second compartment 922 defined by the surrounding wall 921, with a second communicating opening 923 penetrating the surrounding wall 921, communicating with the second compartment 922, and larger than the first communicating opening 916 of the first vessel 91. Particularly, a second thread 924 is formed on the inner side of the surrounding wall 921 and aligns with the first thread 917 of the first vessel 91. The cover 93 is coupled with the first vessel 91 and covers the entrance opening 915. The partition 94 is flexible and detachably mounted on the inner surface of the surrounding wall 921 to separate the second compartment 922 into a first section “a” and a second section “b,” with the first section “a” communicating with the second communicating opening 923 and the second section “b” being sealed by the surrounding wall 921 and partition 94.

In assembly, the first vessel 91 is partially received in the second vessel 92, with the first and second threads 917, 924 engaged with each other and the end 912 closely abutting against the partition 94. Accordingly, a first material can be received in the first compartment 914 of the first vessel 91, and a second material can be received in the second section “b” of the second compartment 922 of the second vessel 92. When the first vessel 91 is rotated relatively to the second vessel 92 for the end 912 to further move towards the partition 94 by the first and second threads 917, 924, the partition 94 will finally be strongly pushed to shift and disengaged from the inner surface of the surrounding wall 921. Therefore, the originally separated first and second materials may be mixed up for users to use.

However, there are still some drawbacks of the above illustrated container. When the container with the separated materials is previously made, the first vessel 91 may be rotated relatively to the second vessel 92 in a reverse direction to disengage from second vessel 92 by mistake or during conveyance. In this situation, the loosed first vessel 91 may leak the first material out or let outer contaminants enter the first compartment 914 to pollute the received first material. As a result, the first material received in the first compartment 914 may be less than desired, and the percentage of the first material to the mixture of the first and second materials will thus be different from a designed value, which can be harmful or even fatal to a patient receiving the mixture by injection. Otherwise, outer contaminants in the first material can cause deterioration and a shorten validity of the first material.

Therefore, a new container for different materials with an anti-disassembly structure is needed to prevent the container from being unintentionally disassembled.

### SUMMARY OF THE INVENTION

The primary objective of this invention is to provide a container for different materials with anti-disassembly structure that prevent the container from disassembly, so as to avoid leakage or deterioration of material.

The container for different materials with anti-disassembly structure includes a first vessel, a second vessel, a cover, a partition, and an anti-disassembly unit. The first vessel has a lateral wall connecting a first end and a second end, defines a first compartment by the first and second ends and the lateral wall, forms a first communicating opening at the second end communicating with the first compartment, and forms a first thread on an outer surface of the lateral wall. The second vessel has a surrounding wall defining a second compartment, forms a second communicating opening in the surrounding wall to communicate with the second compartment and for the first vessel to insert into the second compartment, and forms a second thread on an inner surface of the surrounding wall for the first thread to engage with. The cover detachably seals an entrance opening formed at the first end of the first vessel or formed in the surrounding wall of the second vessel. The partition is received in the second compartment and detachably coupled with the surrounding wall. The anti-disassembly unit has at least one ratchet formed on one of the first and second vessels and at least one flexible pawl formed on the other one of the first and second vessels, with the at least one ratchet and flexible pawl arranged on a single level and facing each other when the first and second vessels are assembled.

Furthermore, each ratchet of the anti-disassembly unit has a blocking surface, with an included angle between the blocking surface and a section of the outer surface of the lateral wall whereon the ratchet is formed being a right angle or an obtuse angle.

Furthermore, each ratchet of the anti-disassembly unit has a sliding surface, with an included angle between the sliding surface and the section of the outer surface of the lateral wall whereon the ratchet is formed being an acute angle.

Furthermore, each flexible pawl of the anti-disassembly unit has a base end connecting with the inner surface of the surrounding wall and a tail end raised away from a section of the inner surface of the surrounding wall connecting with the base end.

Further scope of the applicability of the present invention will become apparent from the detailed description given hereinafter. However, it should be understood that the detailed description and specific examples, while indicating preferable embodiments of the invention, are given by way of illustration only, since variances will become apparent to those skilled in the art from this detailed description.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows an exploded cross-sectional view illustrating a conventional container for different materials.

FIG. 2 shows an exploded perspective view illustrating a container for different materials with anti-disassembly structure in accordance with a first embodiment of the present invention.

FIG. 3 shows an exploded cross-sectional view illustrating the container in accordance with the first embodiment of the present invention.

FIG. 4a shows a cross-sectional view of a first vessel along a common thread axis in accordance with the first embodiment of the present invention.

FIG. 4b shows a cross-sectional view of a second vessel along a common thread axis in accordance with the first embodiment of the present invention.

FIG. 5 shows a cross-sectional view illustrating the container in use in accordance with the first embodiment of the present invention.

FIG. 6 shows an exploded perspective view illustrating a container for different materials with anti-disassembly structure in accordance with a second embodiment of the present invention.

FIG. 7 shows a cross-sectional view illustrating a container for different materials with anti-disassembly structure in accordance with a third embodiment of the present invention.

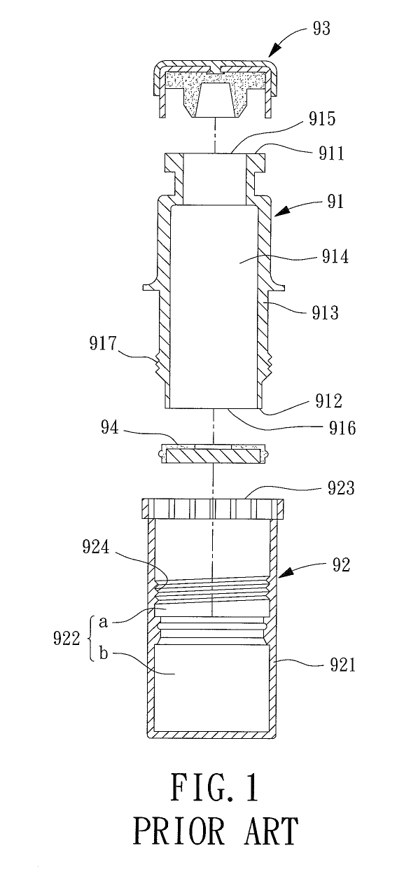

### DETAILED DESCRIPTION OF THE INVENTION

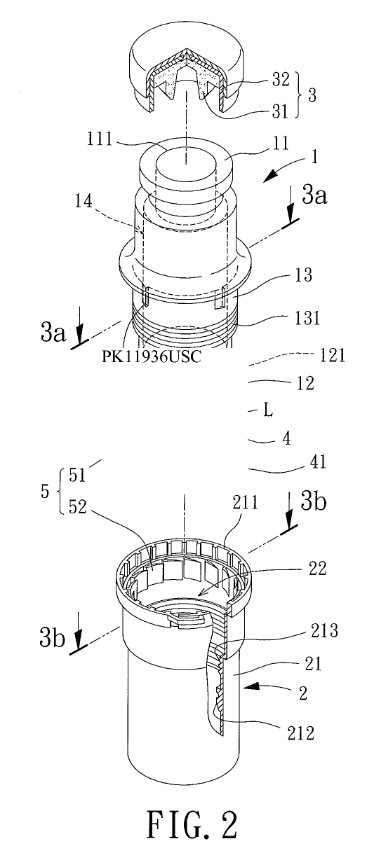

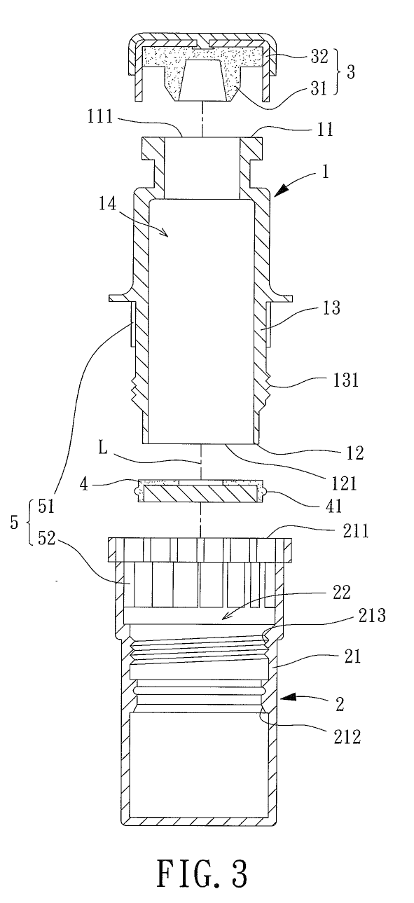

Referring to FIGS. 2 and 3, a first embodiment of the invention is shown, which includes a first vessel 1, a second vessel 2, a cover 3, a partition 4, and an anti-disassembly unit 5.

In detail, the first vessel 1 has a first end 11, a second end 12, a lateral wall 13, and a first compartment 14, with the lateral wall 13 connecting the first and second ends 11, 12 and the first compartment 14 being defined by the first and second ends 11, 12 and the lateral wall 13. An entrance opening 111 is formed at the first end 11, a first communicating opening 121 is formed at the second end 12, and both of the entrance opening 111 and first communicating opening 121 communicate with the first compartment 14. Besides, a first thread 131 is formed on an outer surface of the lateral wall 13, which is preferably adjacent to the first communicating opening 121.

The second vessel 2 is inserted by the first vessel 1 and has a surrounding wall 21 and a second compartment 22 defined by the surrounding wall 21. A second communicating opening 211 is formed in and penetrating the surrounding wall 21 and communicates with the second compartment 22 for the first vessel 1 to insert into the second compartment 22. A part of an inner surface of the surrounding wall 21 forms a retaining member 212, which is preferably an annular groove or a ring with an annular groove on the ring's inner surface. A second thread 213 is formed on the inner surface of the surrounding wall 21 between the second communicating opening 211 and the retaining member 212. Specifically, the first and second threads 131, 213 have a common thread axis “L” for the second thread 213 to engage with the first thread 131 of the lateral wall 13 when the first and second vessels 1, 2 are assembled. In this embodiment, a diameter of the second communicating opening 211 is larger than that of a cross-section of the second end 12, so that the second end 12 of the first vessel 1 can be inserted into the second compartment 22 of the second vessel 2 through the second communicating opening 211 for the first and second threads 131, 213 to be engaged with each other.

The cover 3 is detachably coupled with the first vessel 1 to cover and seal the entrance opening 111. The cover 3 is preferably made by an assembly of a septum stopper 31 and a crimp cap 32 when the present container is applied in medical packaging, with the septum stopper 31 sealing the entrance opening 111 and wrapped by the crimp cap 32 while the crimp cap 32 firmly clamps the first end 11 and the septum stopper 31 together.

The partition 4 is received in the second compartment 22 of the second vessel 2 and detachably coupled with the retaining member 212 of the surrounding wall 21. The partition 4 is preferably a disk with an annular edge 41 able to insert into the annular groove of the retaining member 212. Furthermore, in order to provide a better performance in sealing, at least the annular edge 41 of the partition 4 is flexible.

The anti-disassembly unit 5 has a plurality of ratchets 51 formed on one of the first and second vessels 1, 2 and a plurality of flexible pawls 52 formed on the other one of the first and second vessels 1, 2. The ratchets 51 and flexible pawls 52 are arranged on the same level and face each other when the first and second vessels 1, 2 are assembled to provide an anti-reversal function. In this embodiment, the ratchets 51 are formed on the outer surface of the lateral wall 13 while the flexible pawls 52 are formed on the inner surface of the surrounding wall 21. The ratchets 51 can smoothly slide over the flexible pawls 52 when the first vessel 1 is rotated in a predetermined direction and further enters the second compartment 22 of the second vessel 2 by the first and second threads 131, 213. Contrarily, the ratchets 51 will be stuck by the flexible pawls 52 when the first vessel 1 is rotated in a reverse direction by which the first vessel 1 will be drawn out from the second compartment 22 of the second vessel 2. Accordingly, the anti-disassembly unit 5 may allow the first vessel 1 to rotate in only one way relative to the second vessel 2 to achieve the said anti-reversal function. The details of the ratchets 51 and the flexible pawls 52 are further illustrated clearly as the following.

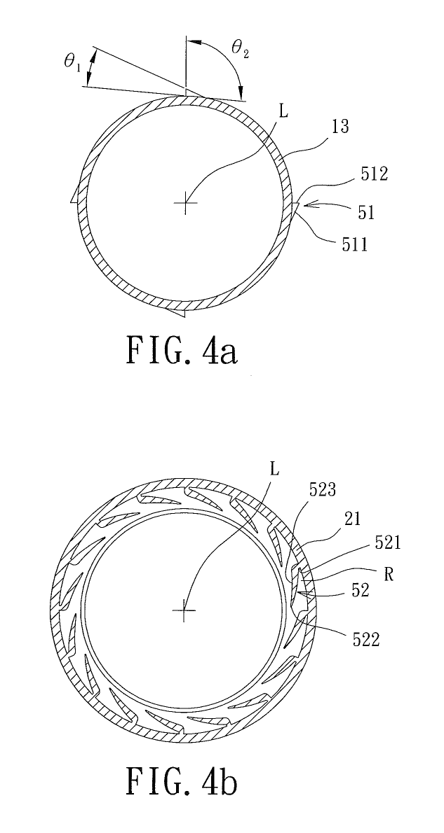

Please refer to FIG. 4a, which is a cross-sectional view of the first vessel 1 along the common thread axis “L” to illustrate the ratchets 51. Each of the ratchets 51 longitudinally extends in a direction essentially perpendicular to the common thread axis “L” of the first and second threads 131, 213, with each ratchet 51 rising from the outer surface of the lateral wall 13 to provide a height. Preferably, each ratchet 51 provides a sliding surface 511 and a blocking surface 512 to enhance the single way rotational efficiency of the first and second vessels 1, 2. In detail, an included angle θ1 between the sliding surface 511 and a section of the outer surface of the lateral wall 13 whereon the ratchet 51 is formed is an acute angle, preferably smaller than 45 degrees. On the other hand, another included angle θ2 between the blocking surface 512 and the section of the outer surface of the lateral wall 13 whereon the ratchet 51 is formed is a right angle or an obtuse angle.

Please refer to FIG. 4b, which is a cross-sectional view of the second vessel 2 along the common thread axis “L” to illustrate the flexible pawls 52. Each flexible pawl 52 is preferably in a blade form, with a base end 521 connecting with the inner surface of the surrounding wall 21, a tail end 522 raised away from a section of the inner surface of the surrounding wall 21 connecting with the base end 521, and an extending part 523 between the base end 521 and tail end 522 inclined to the said section of the inner surface of the surrounding wall 21 so as to define a deforming room “R” between the surrounding wall 21 and extending part 523. Furthermore, at least the tail end 522 of each flexible pawl 52 longitudinally extends in a direction essentially perpendicular to the common thread axis “L”. Accordingly, when pressure is exerted onto the extending part 523, the tail end 522 lowers towards the inner surface of the surrounding wall 21, the extending part 523 is deformed, and the deforming room “R” is reduced; otherwise, the tail end 522 springs upwards and the extending part 523 and deforming room “R” return to the original state when the pressure is removed. Specifically, the said pressure is provided by the sliding surface 511 of the ratchet 51 when the first vessel 1 is revolved about the common thread line “L” relative to the second vessel 2 in the predetermined direction.

In operation, when the first vessel 1 is rotated in the predetermined direction relative to the second vessel 2, the tail end 522 touching the sliding surface 511 of one of the ratchets 51 may slide along the sliding surface 511, move outwards to the surrounding wall 21 gradually, and then return while the flexible pawls 52 totally passes the ratchets 51. However, when the first vessel 1 is rotated in the reverse direction relative to the second vessel 2, the tail end 522 touching the blocking surface 512 of one of the ratchets 51 may stop the rotation of the first vessel 1. Therefore, once these two vessels 1, 2 couple with each other by the first and second threads 131, 213 and the ratchets 51 radially align with the flexible pawls 52, the assembled first and second vessels 1, 2 may not be disassembled and separated. Alternatively, in order to lower the cost in manufacture and to keep the efficiency of anti-reversal function, the number of the ratchets 51 and that of the flexible pawls 52 may also be reduced to one.

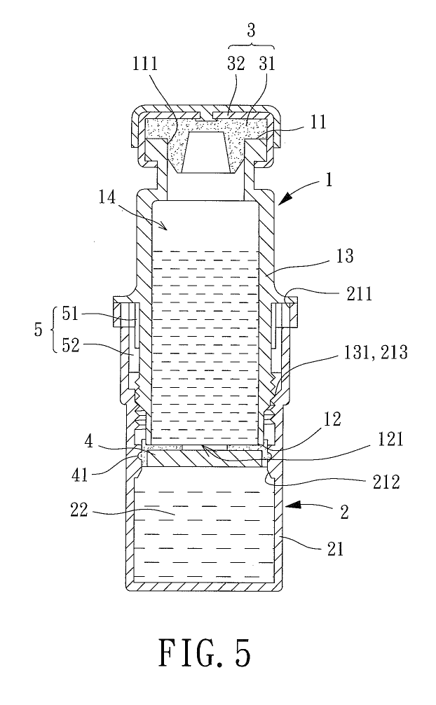

Referring to FIG. 5, when the present container is used to receive two different materials, the partition 4 is coupled with the retaining member 212 to receive one of the materials in a sealed room formed by the surrounding wall 21 and the partition 4 in the second compartment 22; and the first compartment 14 of the first vessel 1 receives the other material in another sealed room formed by the lateral wall 13, cover 3, and partition 4 while the first vessel 1 is inserted into the second vessel 2 through the second communicating opening 211 and the second end 12 abuts against the partition 4. Once the first vessel 1 is rotated relative to the second vessel 2 in the predetermined direction, the first vessel 1 may enter the second compartment 22 further and finally push the partition 4 disengaging from the retaining member 212, so that the first and second materials originally separated by the partition 4 may be mixed with each other. User may obtain the mixture of the first and second materials by directly opening the cover 3 or drawing out the mixture by apparatus such as a syringe needle.

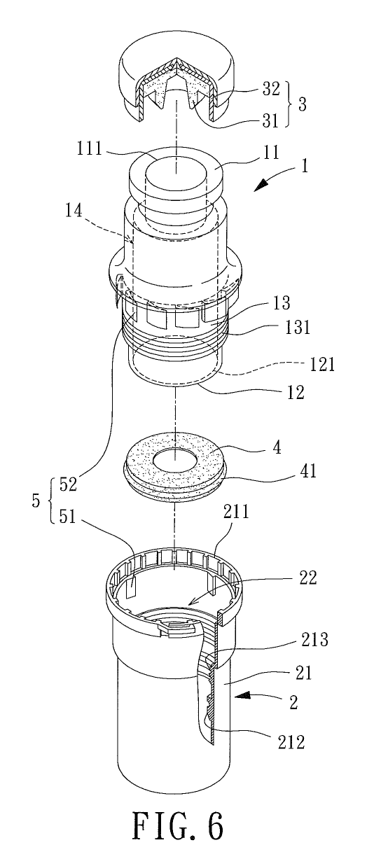

Please refer to FIG. 6, which illustrates a second embodiment of the present invention. In comparison with the first embodiment, the ratchets 51 of the anti-disassembly unit 5 is formed on the inner surface of the surrounding wall 21 and the flexible pawls 52 of the anti-disassembly unit 5 is formed on the outer surface of the lateral wall 1 in this embodiment.

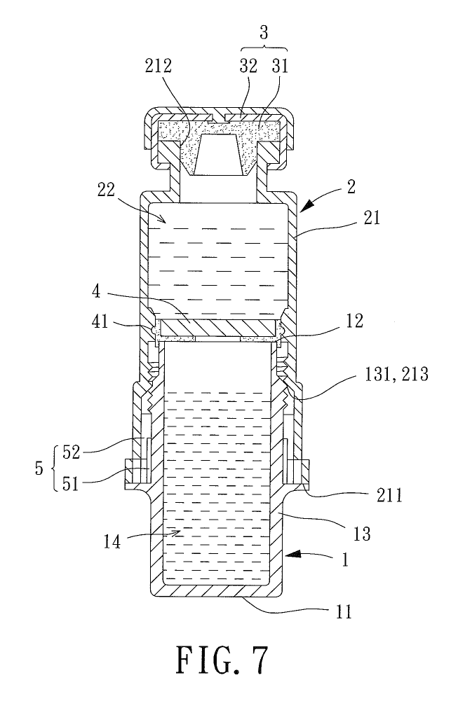

Please refer to FIG. 7, which illustrates a third embodiment of the present invention. In comparison with the first embodiment, the first end 11 is an integrally sealed end instead of forming the entrance opening 111, while an entrance opening 212 allow the cover 3 to seal is formed in the surrounding wall 21, communicates with the second compartment 22, and preferably is opposite to the second communicating opening 211.

As stated above, with the first and second vessels 1, 2 engaged with each other in a screw way and the anti-disassembly unit 5 having the ratchets 51 and flexible pawls 52 respectively formed on the first and second vessels 1, 2, the first vessel 1 is prevented from being rotated in the reverse direction relative to the second vessel 2, so that an anti-disassembly function of the invented container can be achieved since the first vessel 1 is unable to reversely rotate relative to the second vessel 2 and to disengage from the second vessel 2.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A container for different materials with anti-disassembly structure, comprising:
a first vessel having a lateral wall connecting a first end and a second end, defining a first compartment by the first and second ends and the lateral wall, forming a first communicating opening at the second end communicating with the first compartment, and forming a first thread on an outer surface of the lateral wall;
a second vessel having a surrounding wall defining a second compartment, forming a second communicating opening in the surrounding wall to communicate with the second compartment and for the first vessel to insert into the second compartment, and forming a second thread on an inner surface of the surrounding wall for the first thread to engage with;
a cover detachably sealing an entrance opening formed at the first end of the first vessel or formed in the surrounding wall of the second vessel;
a partition received in the second compartment and detachably coupled with the surrounding wall; and
an anti-disassembly unit having at least one ratchet formed on one of the first and second vessels and at least one flexible pawl formed on the other one of the first and second vessels, with the at least one ratchet and flexible pawl arranged on a single level and facing each other when the first and second vessels are assembled.

2. The container for different materials with anti-disassembly structure as defined in claim 1, wherein each ratchet has a blocking surface, with an included angle between the blocking surface and a section of the outer surface of the lateral wall whereon the ratchet is formed being a right angle or an obtuse angle.

3. The container for different materials with anti-disassembly structure as defined in claim 2, wherein each ratchet has a sliding surface, with an included angle between the sliding surface and the section of the outer surface of the lateral wall whereon the ratchet is formed being an acute angle.

4. The container for different materials with anti-disassembly structure as defined in claim 1, wherein each ratchet longitudinally extends in a direction essentially perpendicular to a common thread axis of the first and second threads.

5. The container for different materials with anti-disassembly structure as defined in claim 1, wherein each flexible pawl has a base end connecting with the inner surface of the surrounding wall and a tail end raised away from a section of the inner surface of the surrounding wall connecting with the base end.

6. The container for different materials with anti-disassembly structure as defined in claim 5, wherein the tail end of each flexible pawl longitudinally extends in a direction essentially perpendicular to a common thread axis of the first and second threads.

7. The container for different materials with anti-disassembly structure as defined in claim 1, wherein the inner surface of the surrounding wall forms a retaining member for the partition to detachably couple with, while the second thread is arranged between the retaining member and the second communicating opening.

8. The container for different materials with anti-disassembly structure as defined in claim 7, wherein the retaining member is an annular groove or a ring with an annular groove on the ring's inner surface.

9. The container for different materials with anti-disassembly structure as defined in claim 8, wherein the partition is a disk with an annular edge inserting into the annular groove of the retaining member.
